(19) United States
(12) Patent Application Publication
(10) Pub. No.: US 2011/0226758 A1
(43) Pub. Date: Sep. 22, 2011

(54) ELECTROMAGNETIC OVEN CIRCUIT BASED ON SOC CHIP

(76) Inventors: Shouqing Qiu, Guangdong (CN); Samson Xu, Guangdong (CN); Chunguang Liu, Guangdong (CN); Peng Li, Guangdong (CN); Jinfeng Chen, Guangdong (CN)

(21) Appl. No.: 12/992,944

(22) PCT Filed: Dec. 4, 2009
(86) PCT No.: PCT/CN09/01365

§ 371 Date: Nov. 16, 2010

(30) Foreign Application Priority Data
Dec. 12, 2008 (CN) 200810218354.8

(51) Int. Cl. H05B 6/06

(52) U.S. Cl. 219/660

(57) ABSTRACT

An electromagnetic oven circuit based on SoC chip includes a power inversion circuit and a CHK-S008 type SoC chip. A CPU, comparators, an operational amplifier, an A/D converter, and an IGBT drive control module are integrated into this chip. The circuit further includes a feedback excitation IGBT driver including the IGBT drive control module, the comparator, an external driver, and an external feedback circuit connected between the output of the IGBT drive control module and the in-phase input terminal of the comparator, the output of the comparator is connected to the feedback terminal of the IGBT drive control module, the external driver is connected between the output of the drive control module and the input of the power inversion circuit for driving the power inversion circuit to work. The external feedback circuit feeds back the pulse signal into the chip to modify the IGBT drive waveform and optimize the pulse signal waveform, which improves the work efficiency; at the same time, an excitation effect may be generated in the case of a weak synchronization signal by the external feedback circuit, preventing the synchronization signal from failing when the commercial power is low.

### FIELD OF THE INVENTION

The present invention relates to the technical field of the electromagnetic oven that is heated by the electric power, and particularly to an electromagnetic oven circuit based on SoC (System on a Chip) chip.

### BACKGROUND OF THE INVENTION

Recently, in the application circuit of the mainstream household electromagnetic oven, four comparators or two comparators and discrete components such as a plurality of resistors, capacitors, diodes and transistors or the like are usually adopted to form the synchronize, resonance, drive or current surge protection circuits, etc., which may realize a main resonance circuit and various basic protection functions in connection with the MCU control. Such existing circuit has some drawbacks in that the number of components is large, the number of failure points is large, it is greatly difficult to perform production and maintenance, and the entire cost is high.

For most of the electromagnetic ovens, the system synchronization signal is generated by sampling the IGBT source voltage and DC voltage at both ends of the LC resonance loop and then performing the comparison processing by a comparator. When the commercial power is low, however, the sampling signal is weak, which tends to result in no reversal of the comparator and the failed synchronization.

### SUMMARY OF THE INVENTION

In order to avoid the above mentioned drawbacks presented in the existing electromagnetic oven technology, the present invention provides an electromagnetic oven circuit based on SoC chip. A CPU, several comparators, an operational amplifier and an IGBT drive control module controlled by the CPU are integrated in the SoC chip, and various protection circuits which are designed optimally are configured to improve the reliability of the work of the electromagnetic oven and reduce the production cost.

The electromagnetic oven circuit based on SoC chip according to the present invention includes a rectifier bridge, a filter, a power inversion circuit composed of IGBT and LC resonance loop and a control unit.

The control unit adopts a CHK-S008 type SoC chip in which a CPU, several comparators each connected to a corresponding input terminal of the CPU, one operational amplifier, an A/D converter and an IGBT drive control module connected to one output terminal of the CPU are integrated.

The electromagnetic oven circuit based on SoC chip further includes:

a feedback excitation IGBT driver which includes the IGBT drive control module in the SoC chip, a first comparator among several comparators in the chip, an external drive circuit and an external feedback circuit connected between the output terminal of the IGBT drive control module and the in-phase input terminal of the first comparator, the output terminal of the first comparator being connected to the feedback terminal of the IGBT drive control module and the external drive circuit being connected between the output terminal of the IGBT drive control module and the input terminal of the power inversion circuit, such that the pulse signal output from the IGBT drive control module is amplified to drive the operation of the power inversion circuit; and

a synchronization signal detection circuit which includes the first comparator in the SoC chip, a synchronization signal sampling circuit connected to the input terminal of the first comparator and the external feedback circuit connected between the output terminal of the IGBT drive control module and the in-phase input terminal of the first comparator, the external feedback circuit feeding back the pulse signal output from the IGBT drive control module to the in-phase input terminal of the first comparator.

A storage is set in the CHK-S008 type SoC chip and a current calibration parameter is stored in an area of the storage for calibrating the power of the electromagnetic oven when a calibration program is executed by CPU.

The SoC chip technology is used for the electromagnetic oven according to the present invention. This SoC chip adopts the technology of CPU kernel control therein, which has some advantages in that the frequency is stable, a power tube control signal is actively output and external interference may not be easily suffered. In addition, the chip is high-integrated and the peripheral application circuit is simple, which considerably decreases the difficulty and cost in production and maintenance.

The feedback excitation IGBT drive circuit composed of the IGBT drive control module in the SoC chip, the external drive circuit and the external feedback circuit is adopted for the electromagnetic oven. The pulse signal output from the IGBT drive control module is fed back into the chip through the external feedback circuit for correcting the IGBT drive waveform, optimizing the waveform of the pulse signal and improving the work efficiency. At the same time, an excitation effect may be generated in the case of a weak synchronization signal by the external feedback circuit, preventing the synchronization signal from failing when the commercial power is low.

### BRIEF DESCRIPTION OF THE DRAWINGS

FIG. 1 is a block diagram illustrating the principle according to the present invention;

FIG. 2 is an embodiment of the circuit diagram thereof;

FIG. 3 is an inner circuit diagram of the CHK-S008 type SoC chip adopted by the embodiment of FIG. 2.

### DETAILED DESCRIPTION OF THE EMBODIMENTS

The present invention will be described in detail with reference to the embodiments.

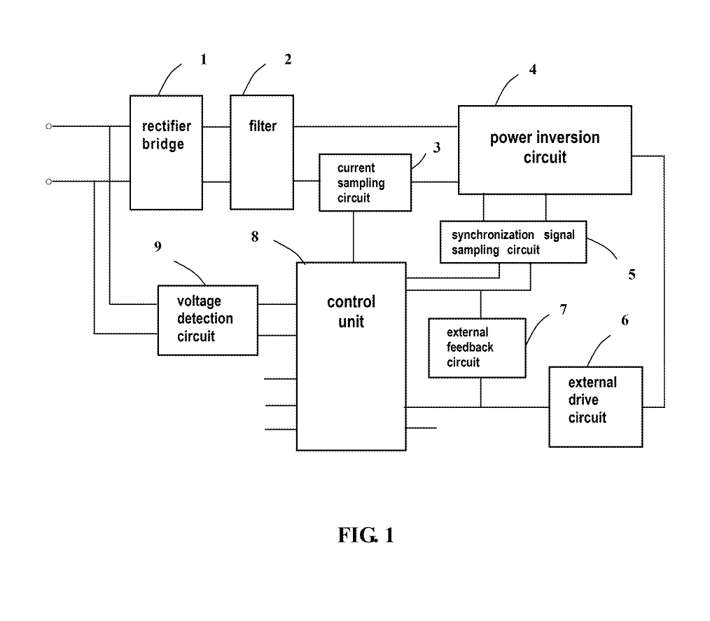

Referring to FIGS. 1-3, the electromagnetic oven circuit mainly includes: a rectifier bridge 1, a filter 2, a power inversion circuit 4 composed of IGBT and LC resonance loop and a control unit 8. There are also provided a current sampling circuit 3, a voltage detection circuit 9 for detecting the voltage signal input into the AC power supply, a synchronized sampling circuit 5, an external drive circuit 6 and an external feedback circuit 7 or the like outside the control unit 8.

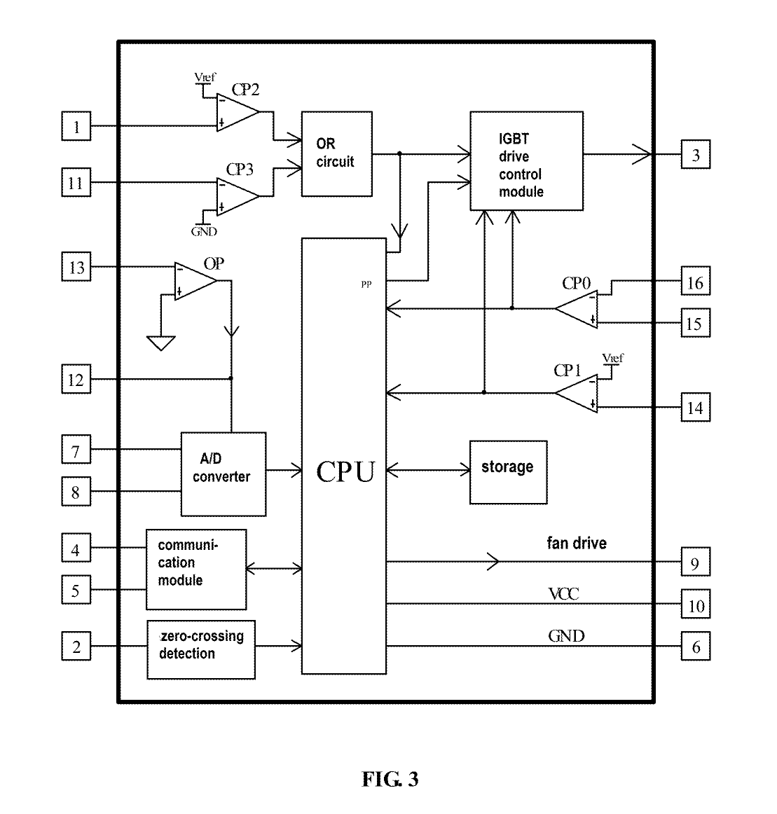

The control unit 8 adopts the CHK-S008 type SoC chip shown in FIG. 3. A CPU, four comparators CP0-CP3 each connected to a corresponding input terminal of the CPU, an operational amplifier OP, an A/D converter and an IGBT drive control module connected to the PP signal (programmable pulse signal) output terminal of the CPU are integrated in the SoC chip. One data communication module for communicating with another MCU or display drive chip as well as a storage and so on are also integrated in the CHK-S008 type SoC chip.

A current calibration parameter is stored in an area of the storage of the CHK-S008 type SoC chip for calibrating the power of the electromagnetic oven when a calibration program is executed by CPU. There is provided a memory area in the storage for storing product information. The product information of the electromagnetic oven may be stored in this memory area, such as the information of bar code of the product, manufacturer number, running number, production date, etc. The product information may be displayed on the digital tube or LED through key-press operation so as to enhance the information secrecy effect and greatly increase the difficulty of counterfeiting products. The CHK-S008 type SoC chip has a 16 PIN encapsulation.

The IGBT drive control module and the comparator CP0 in the SoC chip, the external drive circuit 6 and the external feedback circuit 7 connected between the in-phase input terminal of the comparator CP0 and the output terminal of the IGBT drive control module form a feedback excitation IGBT driver. The output terminal of the comparator CP0 is connected to the feedback terminal of the IGBT drive control module and the external drive circuit 6 is connected between the output terminal of the IGBT drive control module and the input terminal of the power inversion circuit 4 (i.e., the gate of IGBT), such that the pulse signal output from the IGBT drive control module is amplified to drive the operation of the power inversion circuit.

The comparator CP0 in the SoC chip, the synchronized sampling circuit 5 connected to the input terminal of the comparator CP0 and the external feedback circuit 7 form a synchronization signal detection circuit. The external feedback circuit 7 is connected between the in-phase input terminal of the comparator CP0 and the output terminal of the IGBT drive control module and feeds back the pulse signal output from the IGBT drive control module to the in-phase input terminal of the comparator CP0.

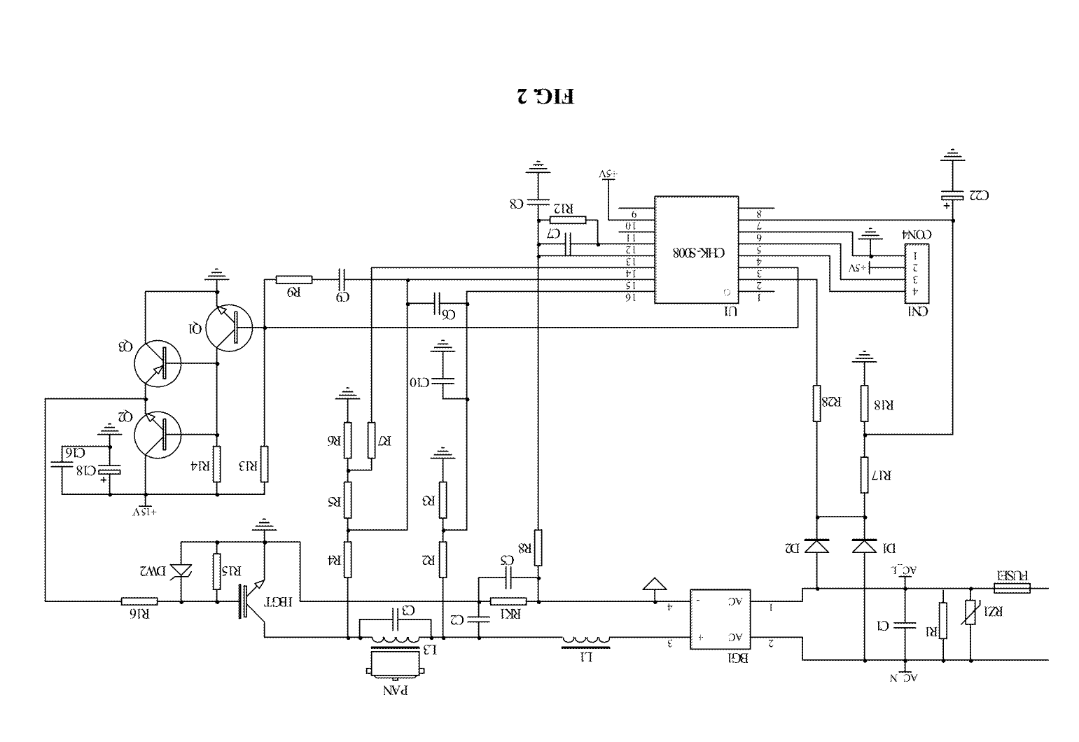

As shown in FIGS. 1 and 2, the rectifier bridge 1, the filter 2 and the power inversion circuit 4 according to the embodiment may use the general circuits, the power inversion circuit 4 being formed by IGBT1 and the LC resonance loop. The LC resonance loop is connected between the source of IGBT and the output terminal of the filter and a resonance coil is provided in a heating plate of the electromagnetic oven. During the operation, a high frequency alternating magnetic field is generated on the resonance inductor and the high frequency alternating magnetic field may generate, through a metallic cooker, the vortex to be converted into heat energy.

The feedback excitation IGBT driver includes: the IGBT drive control module and the comparator CP0 in the CHK-S008 type SoC chip UI, the external drive circuit 6 and the external feedback circuit 7 formed by the resistor R9 and the capacitor C9 connected in series. The external feedback circuit 7 is connected between the output terminal (i.e., 3 Pin of the UI) of the IGBT drive control module and the in-phase input terminal (i.e., 15 Pin of the UI) of the comparator CP0, the output terminal of the comparator CP0 is connected to the feedback terminal of the IGBT drive control module, and the pulse signal output from the IGBT drive control module is fed back into the IGBT drive control module through the external feedback circuit 7 and the comparator CP0 for correcting the IGBT drive waveform, optimizing the waveform of the pulse signal and improving the work efficiency. The external drive circuit 6 is connected between the output terminal of the IGBT drive control module and the IGBT gate of the power inversion circuit 4 for amplifying the pulse signal output from the IGBT drive control module so as to drive the operation of the power inversion circuit.

The external drive circuit 6 is composed of the transistors Q1, Q2, Q3 and the resistors R13, R14. The collector of the Q1 is connected to the positive terminal of the power supply via the R14 and its base is connected to the positive terminal of the power supply via the R13, the bases of the Q2 and Q3 are connected to the collector of the Q1, the collector of the Q2 is connected to the positive terminal of the power supply, the collector of the Q3 and the emitter of the Q1 are both grounded, the emitters of the Q2 and Q3 are connected to each other as an output terminal of the external drive circuit 6 and the output terminal is connected to the gate of the IGBT tube via a current limiting resistor R16, and the base of the Q1 is connected to the output terminal (i.e., 3 Pin of the UI) of the IGBT drive module in the SoC chip UI.

The synchronization signal detection circuit includes the comparator CP0 in the SoC chip UI, the synchronized sampling circuit 5 and the external feedback circuit 7 composed of the resistor R9 and the capacitor C9 connected in series. The external feedback circuit is connected between the in-phase input terminal of the comparator CP0 (i.e., 15 Pin of the UI) and the output terminal of the IGBT drive control module (i.e., 3 Pin of the UI).

The synchronized sampling circuit 5 includes: a series branch formed by the resistors R4, R5 and R6, this series branch being connected to the source of the IGBT for collecting the source voltage of the IGBT; a series branch formed by the resistors R2 and R3 for collecting the DC voltage at the front end of the LC resonance loop as a reference. During the electromagnetic heating, the synchronized sampling signal enters into the comparator CP0 for comparison so as to generate a synchronization signal to be provided to the CPU. When the voltage of the commercial power is low, the input signal across the comparator CP0 is very weak, therefore the comparator has an Offset, at this time, it tends to result in no reversal of the comparator and the failed synchronization. However, a relatively strong signal is generated from the IGBT drive control module in the SoC chip and applied to the in-phase input terminal of the comparator CP0 through the feedback by the R9 and C9, which may generate an excitation effect in the case of a weak synchronization signal, preventing the synchronization signal from failing when the commercial power is low.

The diodes D1 and D2, the resistor dividers R17 and R18 connected to the cathode of the diodes D1 and D2 and the capacitor C22 or the like form a general voltage detection circuit 9. The anodes of the diodes D1 and D2 are connected to the AC input line of the rectifier bridge BGI respectively, and the output of the voltage detection circuit 9 is connected to the input terminal 7 Pin of the SoC chip UI.

A constantan wire resistor RK1 that is connected in series between the rectifier bridge BGI and the drain of the IGBT and a resistor R8 or the like form the current sampling circuit 3. The current sampling circuit 3 and the operational amplifier OP in the SoC chip UI constitute a current detection circuit, and the output of the current sampling circuit 3 is connected to the input terminal 13 Pin of the Soc chip UI. After being converted by the A/D converter in the SoC chip, the current signal output from the current detection circuit and the voltage detection signal output from the voltage detection circuit 9 are input into the CPU for the calculation of the power.

The comparator CP1 in the SoC chip UI and the above mentioned series branch of the synchronized sampling circuit 5 which is composed of the resistors R4, R5 and R6 form a general IGBT reactive high voltage limiting circuit. The public end of the resistors R5 and R6 is connected, through a resistor R7, to the in-phase input terminal of the comparator CP1 (i.e., 14 Pin of the UI) that is connected to the CPU. When the reactive high voltage is detected as exceeding a predefined value, the output power is moderately reduced.

The comparator CP2 in the SoC chip and an external surge voltage sampling circuit may form a voltage surge detection circuit. The comparator CP3 in the SoC chip and an external surge current sampling circuit may form a current surge detection circuit. Therefore, the electromagnetic oven system is provided with the voltage or current surge protection through the CPU and/or the IGBT drive control module.

1. An electromagnetic oven circuit based on SoC chip, comprising a rectifier bridge, a filter, a power inversion circuit composed of IGBT and LC resonance loop and a control unit, wherein:
the control unit adopts a CHK-S008 type SoC chip in which a CPU, several comparators each connected to a corresponding input terminal of the CPU, one operational amplifier, an A/D converter and an IGBT drive control module connected to one output terminal of the CPU are integrated;
and further comprising:
a feedback excitation IGBT driver which comprises the IGBT drive control module in the SoC chip, a first comparator among the several comparators in the chip, an external drive circuit and an external feedback circuit connected between an output terminal of the IGBT drive control module and an in-phase input terminal of the first comparator, an output terminal of the first comparator being connected to a feedback terminal of the IGBT drive control module and the external drive circuit being connected between the output terminal of the IGBT drive control module and an input terminal of the power inversion circuit for driving the operation of the power inversion circuit; and
a synchronization signal detection circuit which comprises the first comparator in the SoC chip, a synchronization signal sampling circuit connected to the input terminal of the first comparator and the external feedback circuit connected between the output terminal of the IGBT drive control module and the in-phase input terminal of the first comparator, the external feedback circuit feeding back the pulse signal output from the IGBT drive control module to the in-phase input terminal of the first comparator.

2. The electromagnetic oven circuit according to claim 1, wherein a storage is set in the CHK-S008 type SoC chip, and a current calibration parameter is stored in an area of the storage for calibrating the power of the electromagnetic oven when a calibration program is executed by CPU.

3. The electromagnetic oven circuit according to claim 2, wherein product information of the electromagnetic oven is stored in a product information memory area of the storage.

4. The electromagnetic oven circuit according to claim 2, wherein a communication module is integrated in the CHK-S008 type SoC chip for exchanging data with another CPU or a display drive chip.

5. The electromagnetic oven circuit according to claim 1, wherein the external drive circuit is composed of transistors Q1, Q2, Q3, a first resistor and a second resistor, the collector of the transistor Q1 is connected to the positive terminal of the power supply via the second resistor and its base is connected to the positive terminal of the power supply via the first resistor, the bases of the transistors Q2 and Q3 are connected to the collector of the transistor Q1, the collector of the transistor Q2 is connected to the positive terminal of the power supply, the collector of the transistor Q3 and the emitter of the transistor Q1 are both grounded, the emitters of the transistor Q2 and Q3 are connected to each other as an output terminal of the external drive circuit and the output terminal is connected to the gate of the IGBT, and the base of the transistor Q1 is connected to the output terminal of the IGBT drive control module in the SoC chip.

6. The electromagnetic oven circuit according to claim 1, wherein the external feedback circuit is composed of a resistor and a capacitor connected in series.

7. The electromagnetic oven circuit according to claim 1, wherein the CHK-S008 type SoC chip has a 16 PIN encapsulation.
